(19) United States
(12) Patent Application Publication
(10) Pub. No.: US 2017/0033524 A1
(43) Pub. Date: Feb. 2, 2017

(54) Ez pivot cord connector

(71) Applicant: Rennard Raymond McCord, Tampa, FL (US)

(72) Inventor: Rennard Raymond McCord, Tampa, FL (US)

(21) Appl. No.: 14/810,258

(22) Filed: Jul. 27, 2015

(51) Int. Cl. H01R 43/00; H01R 35/00

(52) U.S. Cl. CPC H01R 43/00; H01R 35/00

(57) ABSTRACT

A service provided assembled electric power cord adapter which has a rounded insulator body defining a heated shrink wrap enclosure. Assembled at the core of this shrink wrapped enclosure is an electric connector which features two extension ports one of which has a 360 degree rotating feature. Two identical pair of alloyed metal electric receptacles fits securely attached to this electric connector extension ports. A flow of positive and negative electric current is enabled to both when the service provider severs a barber clippers cord and solders clipper cords exposed wires to the exposed wires of the pair of metal electric receptacles. When the electric connector, which features the rotating extension port, is connected with the assembled electric receptacles, an electric path is formed through this cord adapter while giving this invented cord adapter a 360 degree rotating and pivoting advantage from its regular stock cord. This rotating and pivoting advantage prevents barber cords from tangling and twisting while in use.

### BACKGROUND-FIELD OF INVENTION

This invention relates to pivot cord connectors, specifically to such pivot cord connectors which are assembled by a service provider and used to eliminate tangling and twisting of cords when used by a professional barber.

I, Rennard R. McCord, have invented a new utility design adapter for barber clippers as set forth in the following specifications:

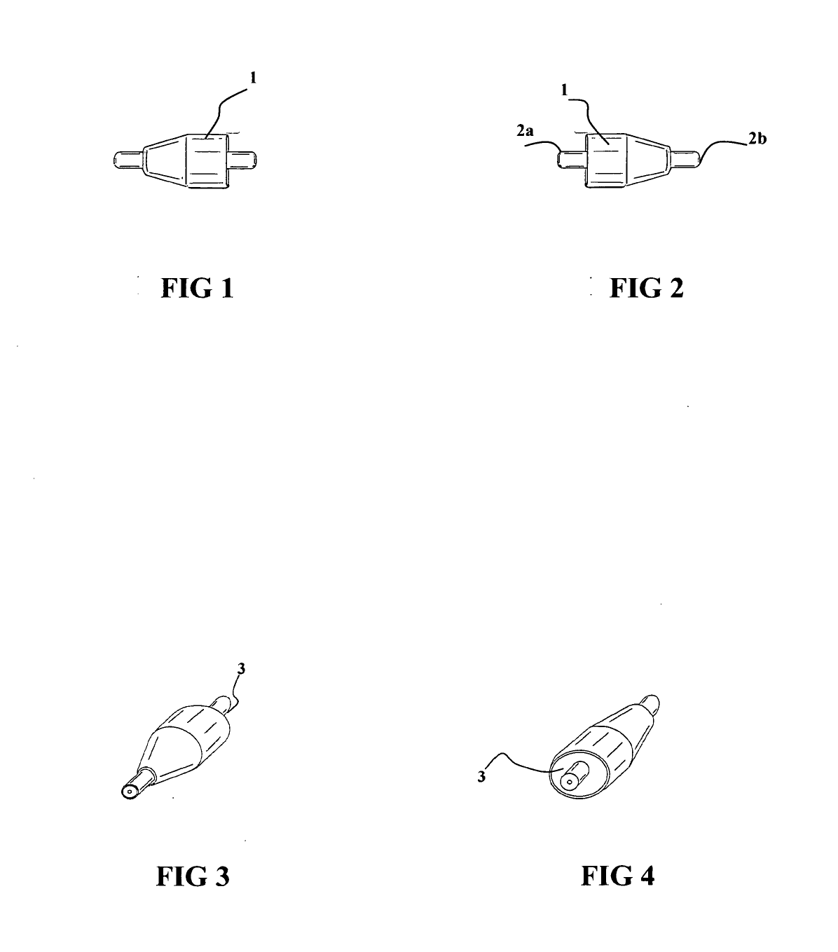

FIG. 1 is a right side view of the standard ½ inch diameter by 1 ⅛ inch length metal alloyed electric connector comprising two ¼ inch diameter connecting ports, which one of these connecting ports rotate 360 degrees used for assembling hand held barbers clippers cord design comprising the first embodiment of the present invention; part of the utility adapter for barber clippers, showing my new design;

FIG. 2 is a left side view of the standard ½ inch diameter by 1 ⅛ inch length metal alloyed electric connector comprising two ¼ inch diameter connecting ports, which one of these connecting ports rotate 360 degrees used for assembling hand held barbers clippers cord design comprising the first embodiment of the present invention; part of the utility adapter for barber clippers, showing my new design;

FIG. 3 is a right side diagonal view of the standard ½ inch diameter by 1 ⅛ inch length metal alloyed electric connector comprising two ¼ inch diameter connecting ports, which one of these connecting ports rotate 360 degrees used for assembling hand held barbers clippers cord design comprising the first embodiment of the present invention; part of the utility adapter for barber clippers, showing my new design;

FIG. 4 is a left side diagonal view of the standard ½ inch diameter by 1 ⅛ inch length metal alloyed electric connector comprising two ¼ inch diameter connecting ports, which one of these connecting ports rotate 360 degrees used for assembling hand held barbers clippers cord design comprising the first embodiment of the present invention; part of the utility adapter for barber clippers, showing my new design;

FIG. 5 is a right side view of one of the two standard identical ¼ inch diameter by 5/16 inch length metal alloyed electric receptacles comprising negative and positive wire extensions used for assembling hand held barbers clippers cord design comprising the second embodiment of the present invention; part of the utility adapter for barber clippers, showing my new design;

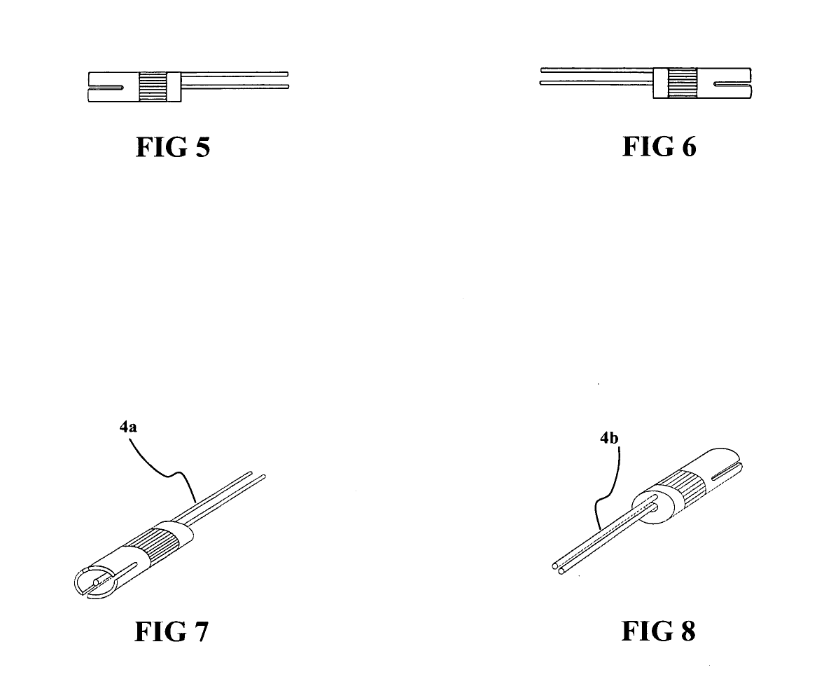

FIG. 6 is a left side view of one of the two standard identical ¼ inch diameter by 5/16 inch length metal alloyed electric receptacles comprising negative and positive wire extensions used for assembling hand held barbers clippers cord design comprising the second embodiment of the present invention; part of the utility adapter for barber clippers, showing my new design;

FIG. 7 is a right side diagonal view of one of the two standard identical ¼ inch diameter by 5/16 inch length metal alloyed electric receptacles comprising negative and positive wire extensions used for assembling hand held barbers clippers cord design comprising the second embodiment of the present invention; part of the utility adapter for barber clippers, showing my new design;

FIG. 8 is a left side diagonal view of one of the two standard identical ¼ inch diameter by 5/16 inch length metal alloyed electric receptacles comprising negative and positive wire extensions used for assembling hand held barbers clippers cord design comprising the second embodiment of the present invention; part of the utility adapter for barber clippers, showing my new design;

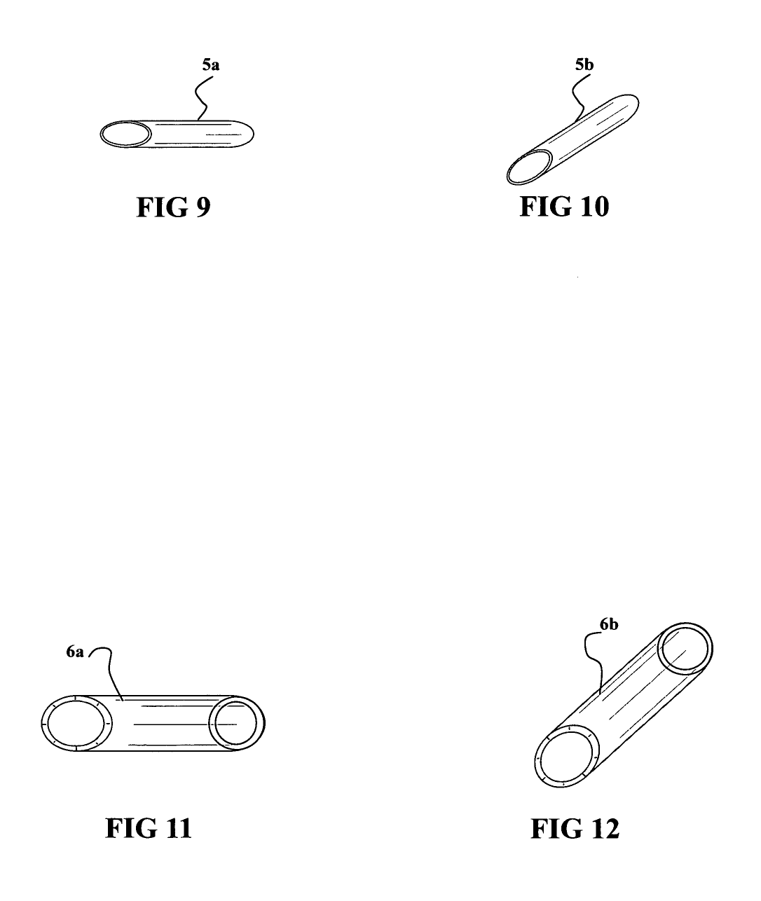

FIG. 9 is a side view of one of the two standard identical ¼ inch diameter by 3 inch length shrink tubing used for assembling hand held barbers clippers cord design comprising the third embodiment of the present invention; part of the utility adapter for barber clippers, showing my new design;

FIG. 10 is a diagonal view of one of the two standard identical ¼ inch diameter by 3 inch length shrink tubing used for assembling hand held barbers clippers cord design comprising the third embodiment of the present invention; part of the utility adapter for barber clippers, showing my new design;

FIG. 11 is a side view of one of the two standard identical ½ inch diameter by 3 inch length plastic aqua tubing used for assembling hand held barbers clippers cord design comprising the forth embodiment of the present invention; part of the utility adapter for barber clippers, showing my new design;

FIG. 12 is a diagonal view of one of the two standard identical ½ inch diameter by 3 inch length plastic aqua tubing used for assembling hand held barbers clippers cord design comprising the forth embodiment of the present invention; part of the utility adapter for barber clippers, showing my new design;

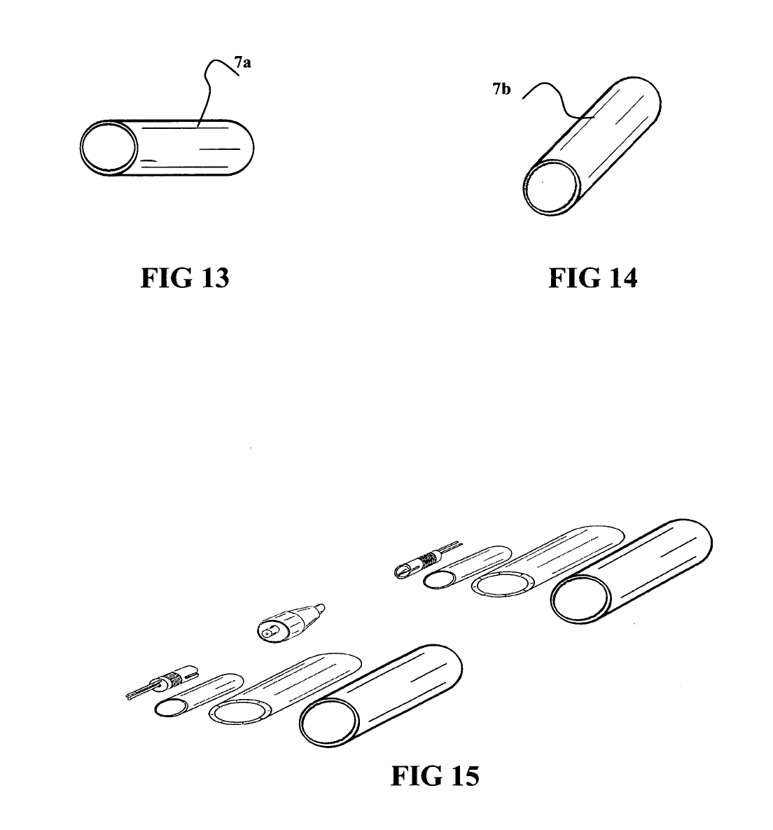

FIG. 13 is a side view of one of the two standard identical ⅝ inch diameter by 3 inch length shrink tubing used for assembling hand held barbers clippers cord design comprising the fifth embodiment of the present invention; part of the utility adapter for barber clippers, showing my new design;

FIG. 14 is a diagonal view of one of the two standard identical ⅝ inch diameter by 3 inch length shrink tubing used for assembling hand held barbers clippers cord design comprising the fifth embodiment of the present invention; part of the utility adapter for barber clippers, showing my new design;

FIG. 15 is a exploded view of all nine sequenced parts of the five preferred embodiments used for assembling hand held barbers clippers cord design of the present invention; part of the utility adapter for barber clippers, showing my new design;

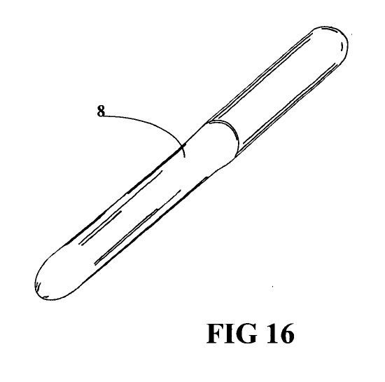

FIG. 16 is a side diagonal view of the assembled appearance of the preferred embodiments used for assembling hand held barbers clippers cord design of the present invention; part of the utility adapter for barber clippers, showing my new design;

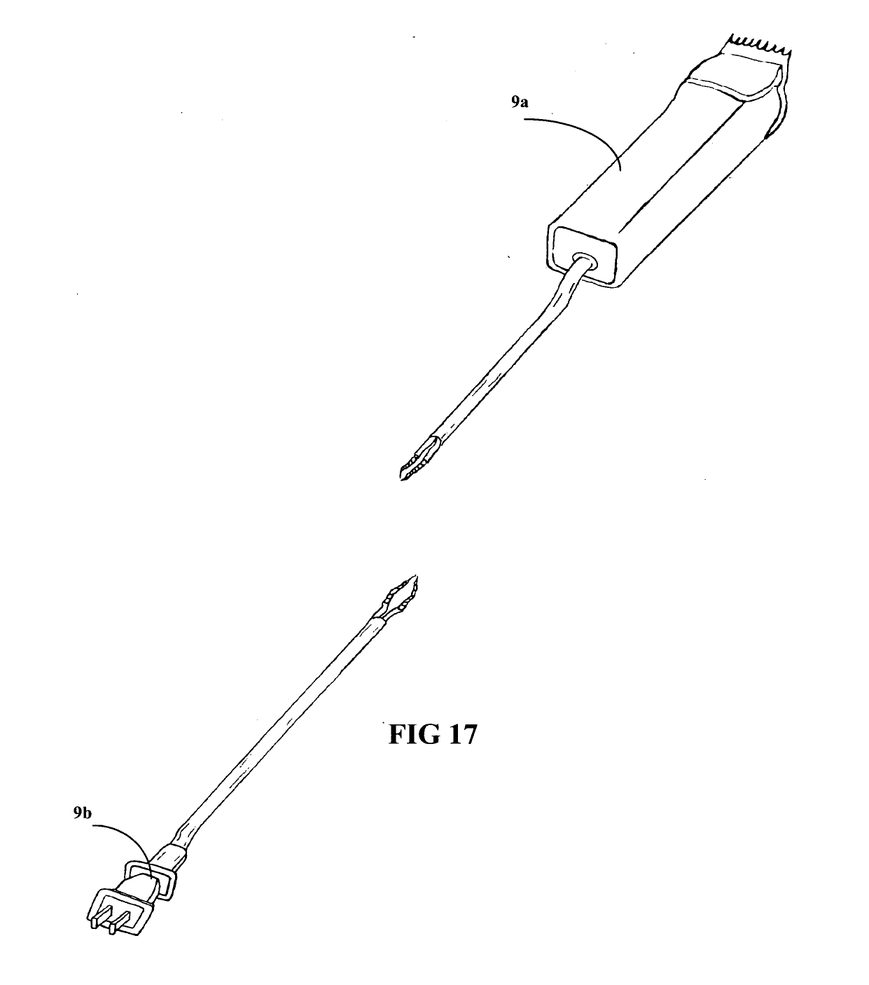

FIG. 17 is a side diagonal view of standard barbers clippers illustrating it's severed plug in end from it's cutting tool end exposing their negative and positive wires used for assembling hand held barbers clippers cord design of the present invention; part of the utility adapter for barber clippers, showing my new design;

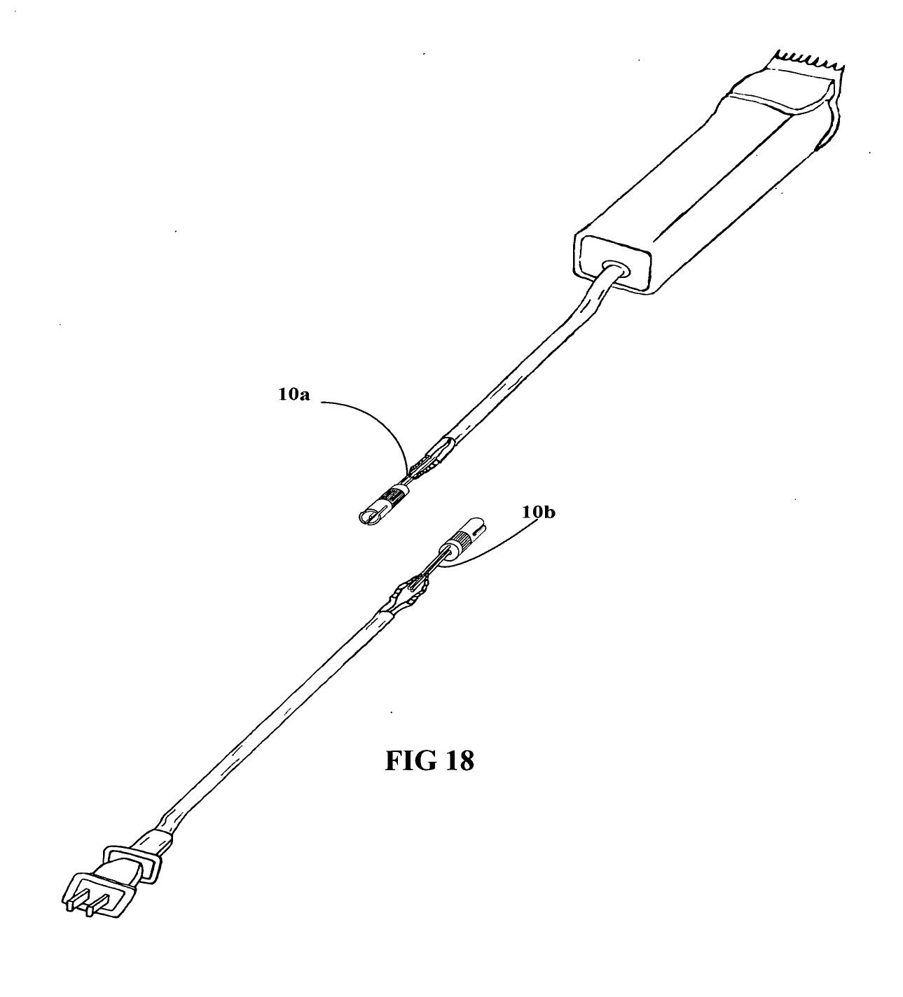

FIG. 18 is a side diagonal view of how the two standard identical ¼ inch diameter by 5/16 inch length metal alloyed electric receptacles will be soldered onto the barbers clippers exposed negative and positive wires used for assembling hand held barbers clippers cord design of the present invention; part of the utility adapter for barber clippers, showing my new design;

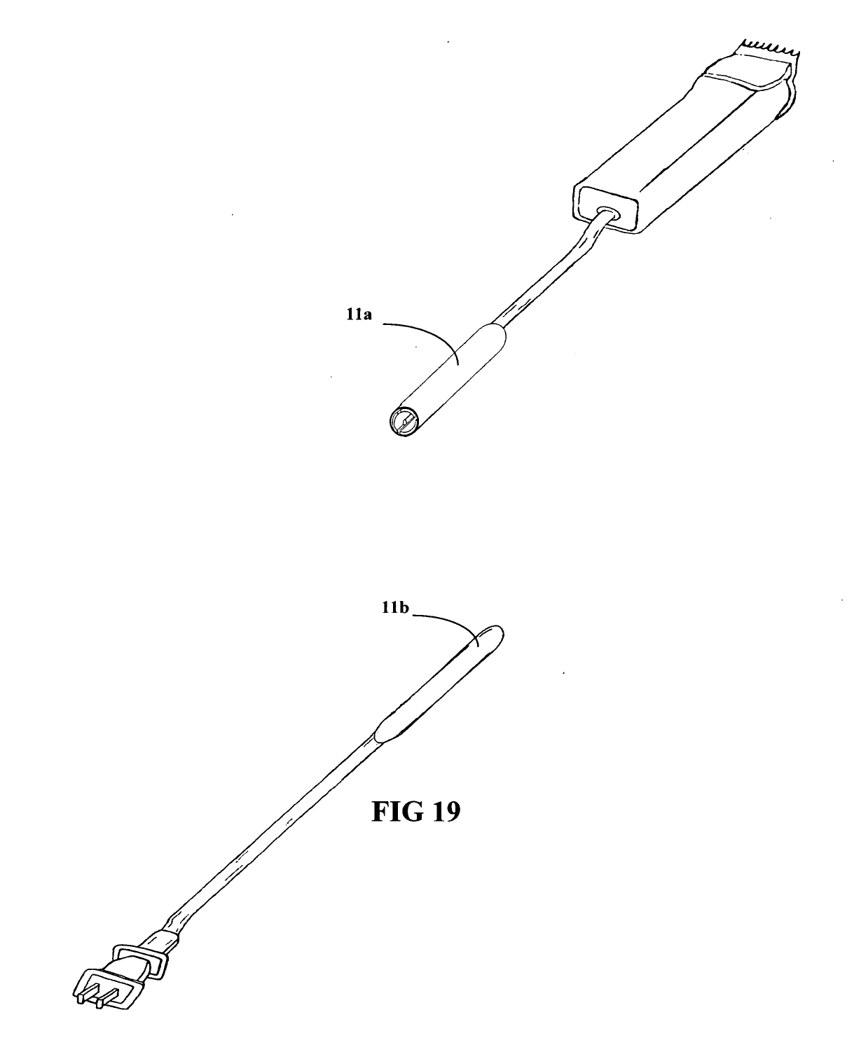

FIG. 19 is a side diagonal view of how the two standard identical ¼ inch diameter by 3 inch length shrink tubing will cover the two standard identical ¼ inch diameter by 5/16 inch length metal alloyed electric receptacles soldered onto the barbers clippers exposed negative and positive wires used for assembling hand held barbers clippers cord design of the present invention; part of the utility adapter for barber clippers, showing my new design;

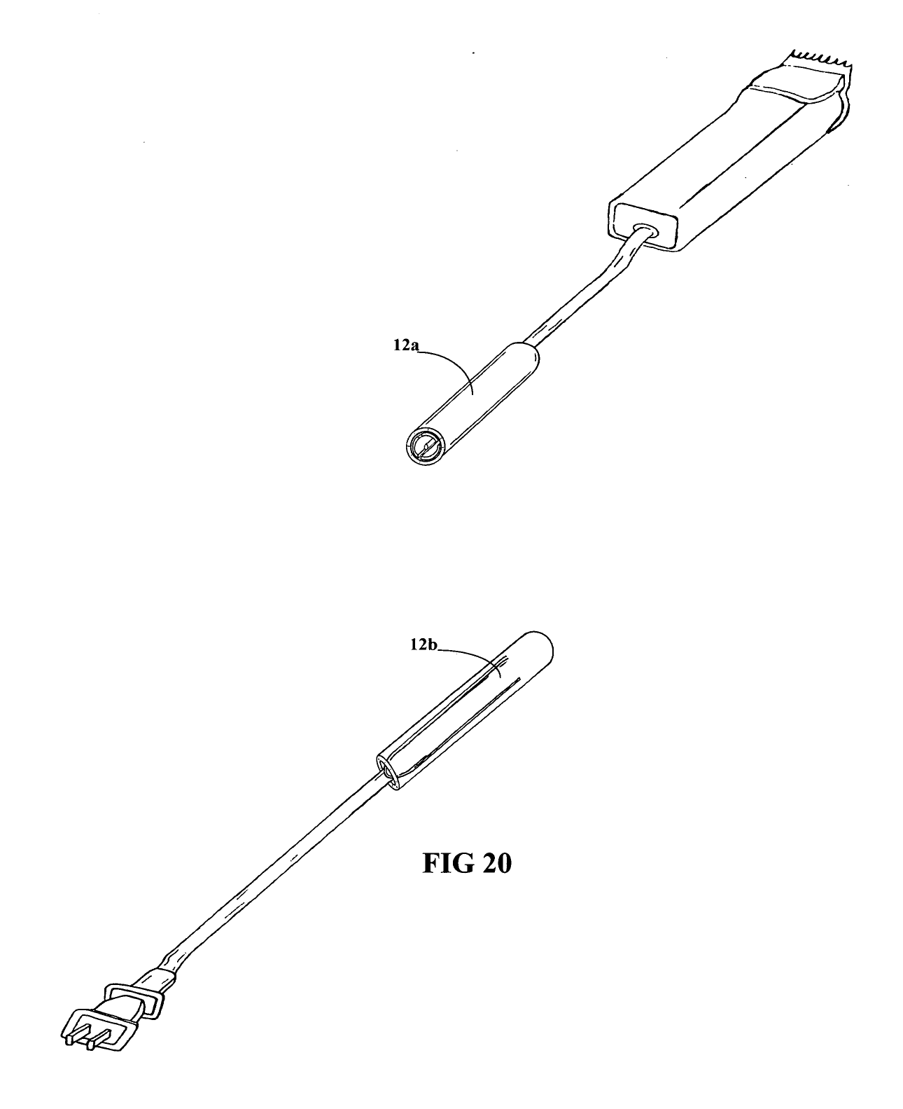

FIG. 20 is a side diagonal view of how the two standard identical ½ inch diameter by 3 inch length plastic aqua tubing will cover the two standard identical ¼ inch diameter by 3 inch length shrink tubing covering the two standard identical ¼ inch diameter by 5/16 inch length metal alloyed electric receptacles soldered onto the barbers clippers exposed negative and positive wires used for assembling hand held barbers clippers cord design of the present invention; part of the utility adapter for barber clippers, showing my new design;

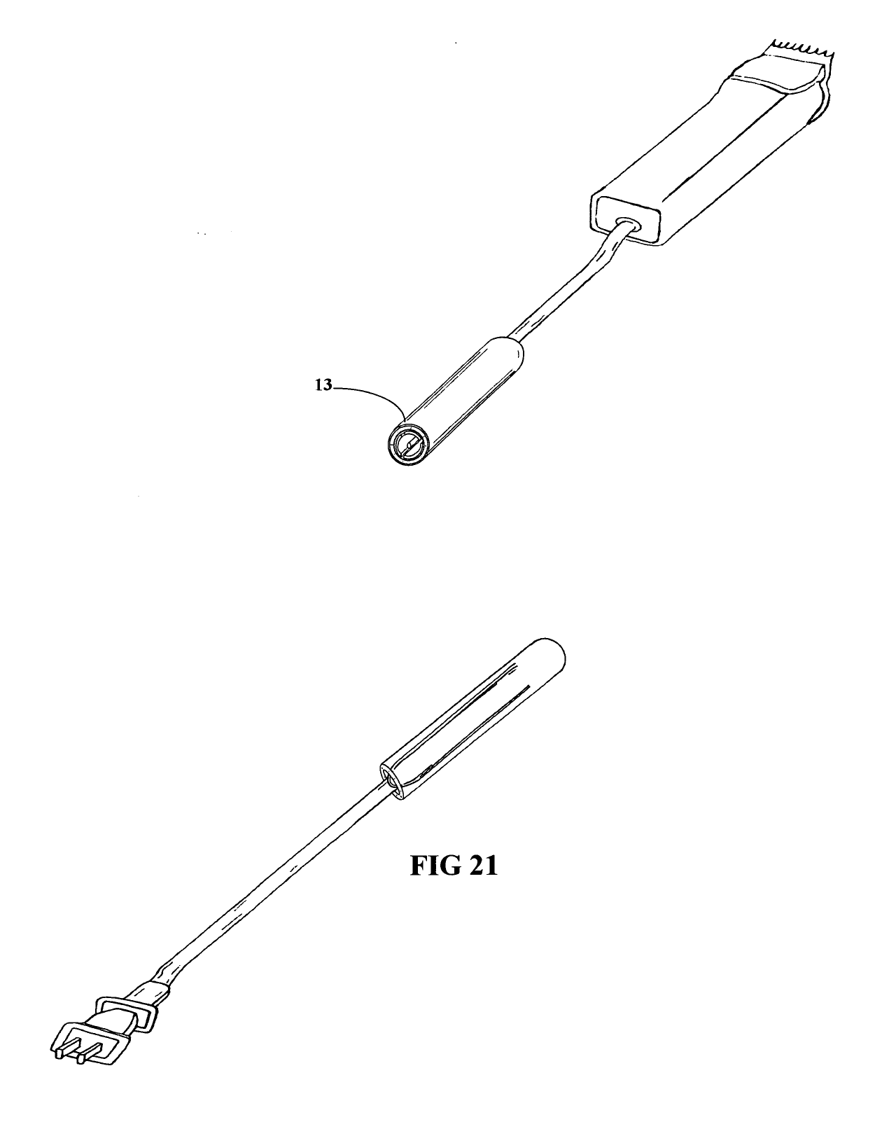

FIG. 21 is a side diagonal view of how one of the two standard identical ⅝ inch diameter by 3 inch length shrink tubing will cover the assembled embodiments attached to the severed cutting tool end of hand held barbers clippers cord design of the present invention; part of the utility adapter for barber clippers, showing my new design;

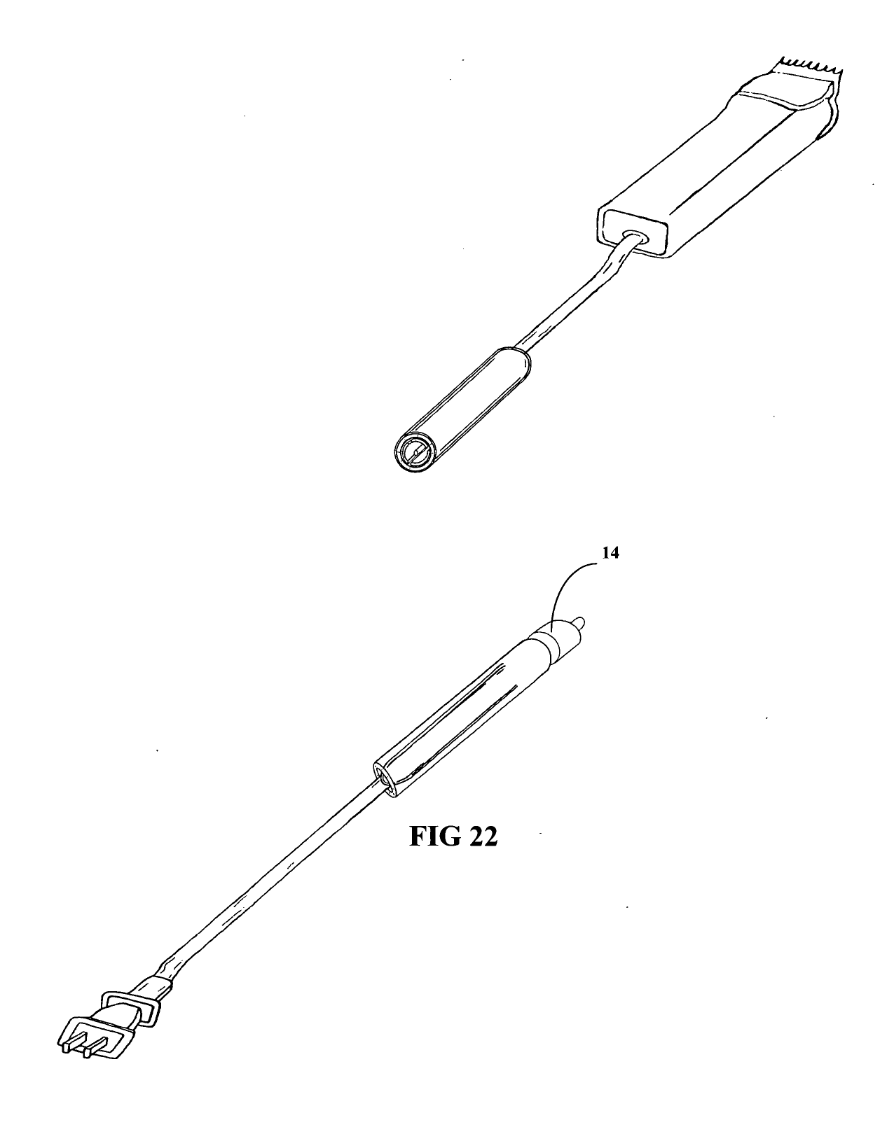

FIG. 22 is a side diagonal view of how the standard ½ inch diameter by 1 ⅛ inch length rotating metal alloyed electric connector comprising ¼ inch diameter negative and positive connecting ports will be connected into one of the two standard identical ¼ inch diameter by 5/16 inch length metal alloyed electric receptacles which is part of the assembled embodiments attached to severed plug in end of hand held barbers clippers cord design of the present invention; part of the utility adapter for barber clippers, showing my new design;

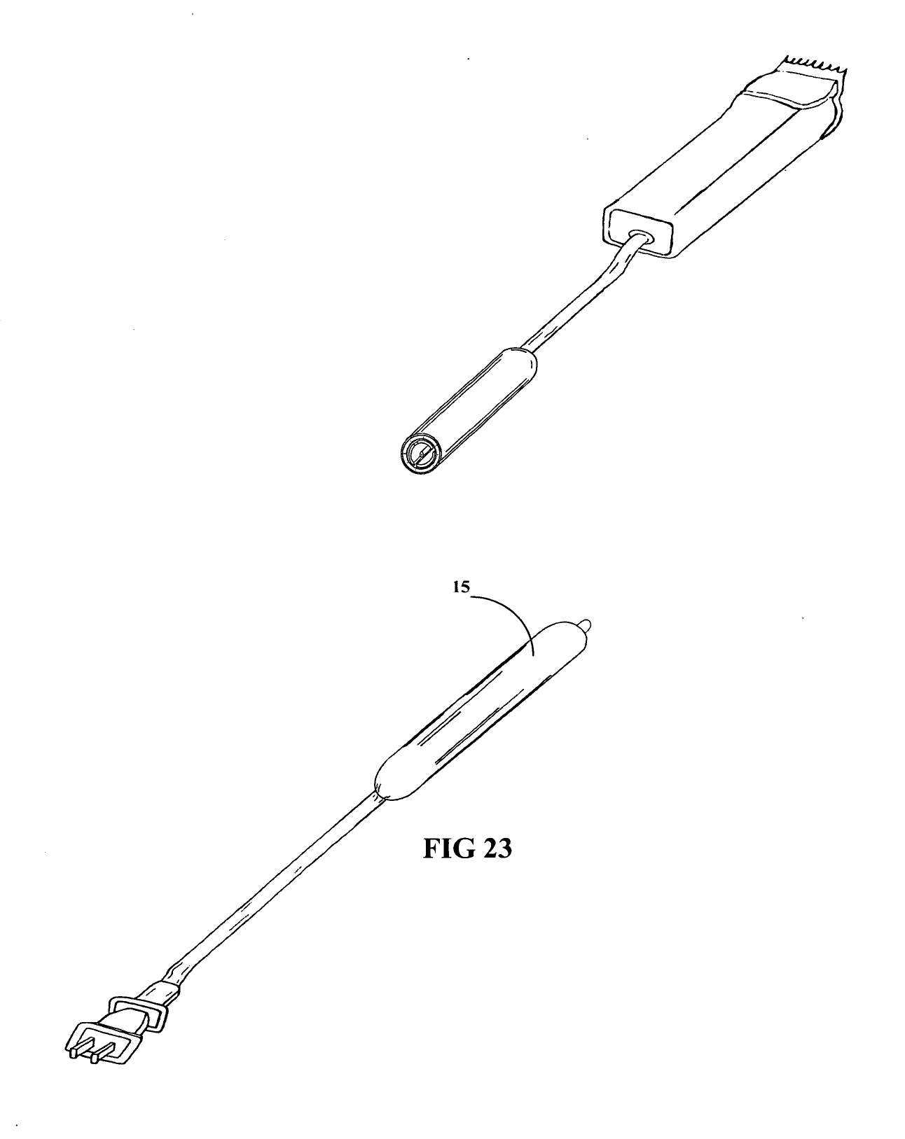

FIG. 23 is a side diagonal view of how the second of the two standard identical ⅝ inch diameter by 3 inch length shrink tubing will cover all assembled embodiments attached to the severed plug in end of hand held barbers clippers cord design of the present invention; part of the utility adapter for barber clippers, showing my new design;

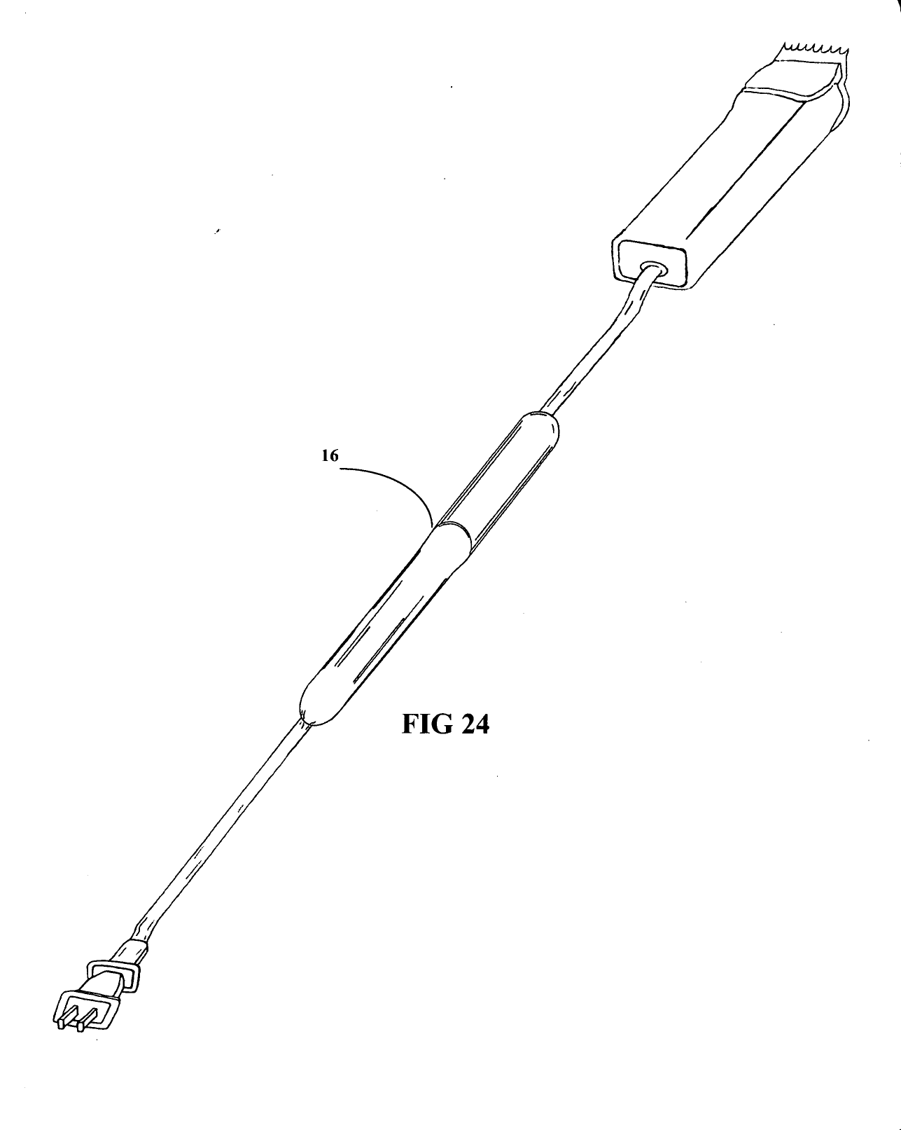

FIG. 24 is a side diagonal view of how the opposite connecting ¼ inch diameter port of the standard ½ inch diameter by 1 ⅛ inch length rotating metal alloyed electric connector will be connected into the remaining standard identical ¼ inch diameter by 5/16 inch length metal alloyed electric receptacle which is part of the assembled embodiments attached to severed cutting tool end of hand held barbers clippers cord design of the present invention; part of the utility adapter for barber clippers, showing my new design.

### DETAIL DESCRIPTION

Referring now to the drawings, and particularly to FIG. 1-4. Shown therein at FIG. 1-2 is a side plan view of the metal alloyed electric connector 1 comprising two 1/4 inch diameter connecting ports 2a and 2b. One of these ¼ inch diameter connecting ports has the capability of rotating 360 degrees 3 at FIGS. 3 and 4. FIGS. 6 and 7 shows the negative and positive extension wires placement of the two standard identical ¼ inch diameter by 5/16 inch length metal alloyed electric receptacles 4a and 4b.

Turning now to the drawings at FIGS. 9 and 10 is a side view and diagonal view of one of the two standard identical ¼ inch diameter by 3 inch length shrink tubing 5a and 5b which helps to insulate the electric connector and the metal alloyed receptacles after tubing is heated and shrinks FIG. 11 and 12 shows a side view and diagonal view of one of the two standard identical ½ inch diameter by 3 inch length plastic aqua tubing 6a and 6b, which are also use to insulate and strengthen the body of this invention. FIG. 13 and 14 is a side view and diagonal view of one of the two standard identical ⅝ inch diameter by 3 inch length shrink tubing 7a and 7b which is used to help insulate the electric connector and receptacles and give a uniform finish to this invention when tubing is heated and shrinks. FIG. 16 is how the invention appears at its finished assembled stage 8.

Referring now to the drawings, and particularly to FIG. 17-24. Shown therein at FIG. 17 is a side diagonal view of standard barbers clippers illustrating it's severed cord plug in end from it's cutting tool end exposing their negative and positive wires 9a and 9b. FIG. 18 is how the two standard identical ¼ inch diameter by 5/16 inch length metal alloyed electric receptacles will be soldered on the exposed wires of severed barbers clippers 10a and 10b. FIG. 19 shows how the pair of ¼ inch diameter by 3 inch length shrink tubing will be assembled over the two identical receptors 11a and 11b. FIG. 20 shows how the pair of ½ inch diameter by 3 inch length aqua tubing will be assembled over the pair of ¼ inch diameter by 3 inch length shrink tubing 12a and 12b. FIG. 21 shows how one of the two ⅝ inch diameter by 3 inch length shrink tubing will be assembled over the aqua tubing at the cord of the cutting tool end of the barbers clippers 13 giving that end a finished assembly. FIG. 22 shows how the electric connector rotating port will be attached to the receptacle assembly at the plug in end of the barbers clippers cord 14. FIG. 23 shows how the remaining ⅝ inch diameter by 3 inch length shrink tubing will be assembled over the electric connector and its assembly at the cord of the plug in end of the barbers clippers 15 giving that end a finish assembly. FIG. 24 shows the finished assembled appearance of this invention when both ends are connected and ready for use 16.

I claim:

1. The process of utilizing a purchased standard electric connector device of the kind comprising two featured extension imports arms, which one of said imports arms has a 360 degree rotating feature therein.

2. The process of utilizing a purchased pair of standard electric receptacle devices of the kind comprising negative and positive extension wires and congruent diameter fitting which firmly attach to electric connector device import arms according to claim 1.

3. The process of utilizing a purchased pair of standard ¼ inch diameter by 3 inch length shrink tubing of the kind which shrinks upon heating to fit said electric receptacles when attached to said electric connector import arms according to claim 2, which shrink tubing supports electric devices and starts to develop a secured housing.

4. The process of utilizing a purchased pair of standard ½ inch diameter by 3 inch length plastic aqua tubing of the kind comprising a stern body composition which covers and protects ¼ inch shrink tubing assembly according to claim 2 and claim 3, which aqua tubing supports electric devices and enhances the development of a secured housing.

5. The process of utilizing a purchased pair of standard ⅝ inch diameter by 3 inch length shrink tubing of the kind which shrinks upon heating to fit said ½ inch plastic aqua tubing and said assembly according to claim 1, claim 2, claim 3 and claim 4, which said shrink tubing completes invention outer housing and completes said invention.
